(19) United States
(12) Patent Application Publication
(10) Pub. No.: US 2012/0022415 A1
(43) Pub. Date: Jan. 26, 2012

(54) MODULAR THERAPEUTIC PRESSURE APPLICATION DEVICES

(75) Inventors: Brian Mullen, Amherst, MA (US); Sundar Krishnamurty, Amherst, MA (US)

(73) Assignee: University of Massachusetts, Boston, MA (US)

(21) Appl. No.: 13/129,027

(22) PCT Filed: Nov. 12, 2009
(86) PCT No.: PCT/US2009/006078

§ 371 Date: Sep. 30, 2011

Related U.S. Application Data
(60) Provisional application No. 61/114,225, filed on Nov. 13, 2008.

(51) Int. Cl. A61H 7/00; B23P 11/00

(52) U.S. Cl. 601/150; 601/148; 29/428

(57) ABSTRACT

The invention relates in some aspects to therapeutic pressure application devices and methods of manufacturing and using the same. In some aspects, the devices comprise a support structure shaped to conform to a portion of a body of an individual; a bladder having a port for the passage of a fluid, the bladder being supported by the support structure; a pump having a fluid outlet, the pump being secured to the support structure; and separable fluid connectors operably connecting the pump with the port.

### RELATED APPLICATION

The present application claims priority under 35 U.S.C. §119(e) to U.S. provisional application, U.S. Ser. No. 61/114,225, filed Nov. 13, 2008, the contents of which are incorporated herein by reference in their entirety.

### BACKGROUND INFORMATION

Tactile stimulus such as deep pressure touch simulation (DPTS) applies pressure to a person much like the feeling of a firm hug, swaddling, or firm petting. DPTS is most often applied using weighted or elastic garments. These devices are often used in hospitals, schools and at home but suffer from a variety of limitations, and consequently, new therapeutic pressure application devices are needed.

### SUMMARY OF THE INVENTION

The invention relates, in some aspects, to therapeutic pressure application devices having a modular design. According to some embodiments, the devices may employ modular components that are interconnected through separable connections. Such a design allows manufacture of therapeutic devices tailored to individual wearers suffering from any of a number of conditions for which deep pressure touch simulation may be beneficial. In some embodiments, the modular design enables an end-user, such as a physician, care-giver, etc., to customize the device to suit the needs of the individual wearer.

According to some aspects of the invention, a therapeutic pressure application device is provided. In some embodiments, the therapeutic pressure application device comprises a support structure shaped to conform to a portion of a body of an individual; a bladder having a port for the passage of a fluid, the bladder being supported by the support structure; a first separable fluid connector coupled to the port; a pump having a fluid outlet, the pump being secured to the support structure; and a second separable fluid connector coupled to the fluid outlet of the pump, the second separable fluid connector being shaped to mate with the first separable fluid connector. In some embodiments, the pump comprises a manually actuated pump.

In some embodiments, the therapeutic pressure application device further comprises at least one lockable pouch secured to the support structure; and the pump is housed in a pouch of the at least one lockable pouch. In some embodiments, the at least one lockable pouch is detachable. In some embodiments, the pump has a first electrical control input; and the therapeutic pressure application device further comprises: a controller comprising a first electrical control output, the controller being configured to generate an electrical control signal at the first electrical control output to automatically control the pump to regulate pressure in the bladder; a first separable electrical connector, the first separable electrical connector coupled to the first electrical control input; and a second separable electrical connector, the second separable electrical connector being shaped to mate with the first separable electrical connector, and the second separable electrical connector being coupled to the first electrical control output. In certain embodiments, the controller is housed in a pouch of the at least one lockable pouches. In certain embodiments, the pouch housing the controller is distinct from the pouch housing the pump.

In some embodiments of the therapeutic pressure application device, the controller comprises a second electrical control input; and the therapeutic pressure application device further comprises: a pressure sensor attached to the support structure, the pressure sensor being configured to generate a signal indicative of a level of pressure at a second electrical control output, a third separable electrical connector coupled to the second electrical control output; a fourth separable electrical connector, the fourth separable electrical connector being shaped to mate with the third separable electrical connector, and the fourth separable electrical connector being coupled to the second electrical control input.

In some embodiments of the therapeutic pressure application device, the bladder comprises a wall; and the pressure sensor comprises a measuring element associated with at least a portion of the wall of the bladder, the measuring element being configured to measure strain in the wall of the bladder. In other embodiments, the bladder comprises a wall; and the pressure sensor comprises a measuring element associated with at least a portion of the wall of the bladder, the measuring element being configured to measure a force applied normal to the wall of the bladder.

In some embodiments of the therapeutic pressure application device, the first separable fluid connector is disposed in the pouch housing the pump. In some embodiments, the portion of the body of the individual is a torso; and the first separable fluid connector, the second separable fluid connector, and the first separable electrical connectors are disposed in the pouch housing the pump.

In some embodiments, the therapeutic pressure application device further comprises a first battery coupled to supply power to the controller; and a second battery coupled to supply power to the pump. In some embodiments, the therapeutic pressure application device further comprises at least one holder attached to the support structure; and a weight in each of the at least one holders.

According to some aspects of the invention, a method of manufacturing a therapeutic pressure application device is provided. In some embodiments, the method comprises selecting a type of pump; selecting a pump of the selected type; coupling a fluid outlet of the pump to a bladder secured to a support structure, the support structure being shaped to conform to a portion of a body of an individual; and placing the pump within a lockable pouch secured to the support structure. In some embodiments, the method further comprises selecting a type of controller; selecting a controller of the selected type; connecting the selected controller to the selected pump; connecting a first battery to the selected controller; and connecting a second battery to the selected pump. In some embodiments, selecting the type of controller comprises selecting between a first type of controller with a wireless control input and a second type of controller without a wireless control input. In some embodiments, the method further comprises selecting at least one pressure profile based on an intended wearer of the therapeutic pressure application device; and programming a memory coupled to the controller with the at least one pressure profile.

According to other aspects of the invention, a method of applying a deep pressure touch stimulation to an individual is provided. In some embodiments, the method comprises attaching a therapeutic pressure application device to a portion of a body of the individual, the therapeutic pressure application device comprising a bladder and a plurality of modular components interconnected through separable connections, the modular components comprising at least a pump and a controller, and causing the controller to control the pump to regulate pressure in the bladder while the individual is wearing the device, thereby applying a deep pressure touch stimulation to the individual. In some embodiments, causing the controller to control the pump comprises sending a control signal wirelessly to the controller from a location remote from the therapeutic pressure application device. In some embodiments, the method further comprises observing a behavior of the individual; and generating the control signal based on the observed behavior. In some embodiments, the method further comprises securing weights to the support structure. In certain embodiments, securing the weights comprises inserting the weights into lockable holders. In some embodiments, the therapeutic pressure application device comprises a plurality of straps; and the method further comprises tightening the straps around a torso of the individual to augment the deep pressure touch stimulation to the individual.

According to other aspects of the invention, the method of applying a deep pressure touch stimulation to an individual comprises selecting a pressure profile; attaching a therapeutic pressure application device to a portion of a body of the individual, the therapeutic pressure application device comprising a bladder, a pump and a controller, and while the individual is wearing the device, with the controller, controlling the pump to regulate pressure in the bladder to apply a deep pressure touch stimulation to the individual in accordance with the selected pressure profile. In some embodiments, the therapeutic pressure application device comprises a memory coupled to the controller; and selecting the pressure profile comprises selecting the pressure profile from among a plurality of pressure profiles stored in the memory. In some embodiments, the method further comprises determining at least one parameter characterizing a state of the individual; and selecting the pressure profile from among the plurality of pressure profiles comprises selecting based on the at least one parameter. In some embodiments, the therapeutic pressure application device comprises a memory coupled to the controller; and selecting the pressure profile comprises downloading the pressure profile into the memory from an external device. In certain embodiments, the controller comprises a wireless receiver; and controlling the pump to regulate pressure in the bladder comprises operating the controller in response to a signal received through the wireless receiver, the signal representing the pressure profile.

According to other aspects of the invention, a therapeutic pressure application device is provided that comprises a support structure shaped to conform to a portion of a body of an individual; a bladder having a port for the passage of a fluid, the bladder being supported by the support structure; a pump having a fluid outlet coupled to the port of the bladder, the pump having a control input; and a controller having an output coupled to the control input of the pump, the controller comprising at least one computer storage medium, the computer storage medium comprising instructions, executable by the controller, that when executed by the controller cause the controller to transmit control signals to the pump, the control signals activating the pump to transport fluid into or out of the bladder in accordance with a pressure profile stored in a portion of the at least one computer storage medium. In some embodiments, the device further comprises a pressure sensor disposed adjacent to the bladder, the pressure sensor providing an output indicative of a sensed pressure; and the instructions cause the controller to transmit control signals to the pump based on the sensed pressure and the pressure profile. In some embodiments, the therapeutic pressure application device further comprises a programming port adapted to receive data representative of the pressure profile and to store the data in the portion of the at least one computer storage medium.

According to other aspects of the invention, the method of applying a deep pressure touch stimulation to an individual comprises attaching a therapeutic pressure application device to a portion of a body of the individual, the therapeutic pressure application device comprising a bladder; sensing a perceivable condition of the individual; and controlling the pressure in the bladder in response to the perceivable condition. In some embodiments, the perceivable condition comprises: a sound produced by the individual or an affect of the individual. Accordingly, in some embodiments, sensing the perceivable condition comprises detecting a sound produced by the individual. In other embodiments, sensing the perceivable condition comprises analyzing a video comprising movements or facial expressions of the individual.

According to other aspects of the invention, a therapeutic pressure application device is provided that comprises a support structure shaped to conform to a portion of a body of an individual; a bladder having a port for the passage of a fluid, the bladder being supported by the support structure; a pump having a fluid outlet coupled to the port of the bladder, the pump having a control input; and a controller having an output coupled to the control input of the pump and an input adapted to receive at least one parameter representing a perceivable condition of a wearer of the therapeutic pressure application device, the controller comprising at least one computer storage medium, the computer storage medium comprising instructions, executable by the controller, that when executed by the controller cause the controller to transmit control signals to the pump, the control signals activating the pump to transport fluid into or out of the bladder, at times determined at least in part by the at least one parameter representing a perceivable condition of the wearer. In some embodiments, the therapeutic pressure application device further comprises an accelerometer secured to the support structure, the accelerometer having an output coupled to the input of the controller. In some embodiments, the therapeutic pressure application device further comprises a physiological sensor coupled to input of the controller, wherein the physiological sensor senses a parameter representing a physiological condition, and wherein the instructions cause the controller to transmit the control signals to the pump at times determined in further part by the parameter representing the physiological condition. In certain embodiments, the physiological condition is selected from the group consisting of: heart rate, body temperature, galvanic skin response, muscle tension, blood pressure, respiratory activity, and brain wave activity.

### BRIEF DESCRIPTION OF THE DRAWINGS

FIG. 1A is a pictorial illustration of a therapeutic pressure application device;

FIG. 1B is an enlarged view of a portion, indicated by the line “FIG. 1B,” of the therapeutic pressure application device of FIG. 1A;

FIG. 2A is a cross sectional illustration of the multi-layered therapeutic pressure application device;

FIG. 2B is a cross sectional illustration of an alternative embodiment multi-layered therapeutic pressure application device;

FIG. 3 is a pictorial illustration of a therapeutic pressure application device that is removably and replaceably mounted within a garment;

FIG. 4 is a system block diagram of the pneumatic and electronics system of the pressure application device;

FIG. 5 illustrates a plot of applied pressure versus time;

FIG. 6 is a block diagram of a system including a therapeutic pressure application device;

FIG. 7 is a flowchart of a method of manufacturing a therapeutic pressure application device; and

FIG. 8 is a flowchart of a method of operating a therapeutic pressure application device.

### DETAILED DESCRIPTION

Briefly, according to an aspect of the present invention, a therapeutic pressure application device includes an air bladder having an opening through which air passes into and out of the bladder. A pump provides air to the bladder through the opening. The device also includes a lockable pouch that is removable and replaceably attached to the therapeutic pressure application device. The bladder may be removably and replaceably secured to the garment.

A pressure sensor may sense pressure and provide a pressure signal indicative thereof to a controller, which may automatically control the pump to regulate pressure. The pressure sensor may sense applied pressure or air pressure within the air bladder. To sense applied pressure one or more pressure sensors may be located on the exterior of the upper body therapeutic pressure application device to sense pressure applied by the device against the torso of the wearer. In a manual mode of operation, a user may manually initiate inflation or deflation of the vest by simply pressing an associated inflation or deflation switch/button. In some embodiments of a manual mode of operation, a user may manually inflate the vest by operating a hand pump.

The pressure application device may be removably and replaceably secured to the garment via hook-and-loop fasteners, buttons or other similar quick connect/disconnect mechanisms. For example, a surface of the garment may include a hook fastener, while a cooperating surface of the pressure application device may include cooperating loop tape, which together provide the hook-and-loop fastener. The air bladder is preferably secured to an interior surface of the garment such that the pressure application device is not visible while being worn by a user.

To facilitate comfort and conform to the shape of the wearer, the air bladder may include a plurality of air bladder segments. Each air bladder segment may be pneumatically connected to an adjacent air bladder segment to facilitate inflation and deflation of the bladder segments. Alternatively, each air bladder segment may be pneumatically connected directly to the pump, such that air flow passes directly into each segment from the pump.

The battery may be a rechargeable battery that powers the pump, controller and pressure sensor. The pump, the controller and the battery may be operably located in the pouch. In addition, the pump, the controller and the battery may all be disconnected from the air bladder when the pouch is detached from the air bladder.

The garment independent upper body therapeutic pressure application device may also include a back pack, where the air bladder is attached to the back pack.

These and other objects, features and advantages of the present invention will become more apparent in light of the following detailed description of preferred embodiments thereof, as illustrated in the accompanying drawings.

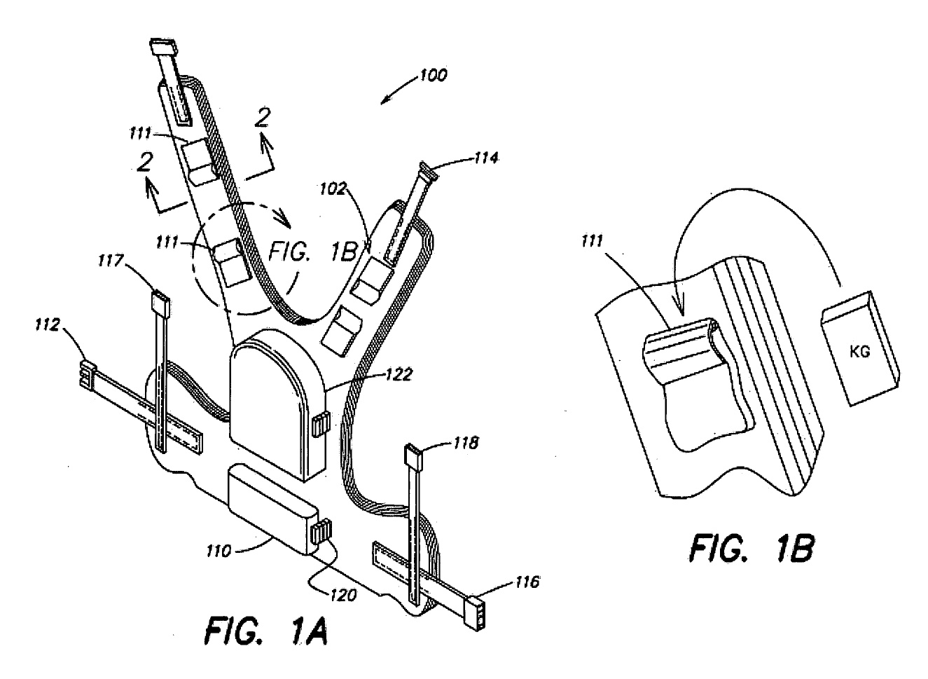

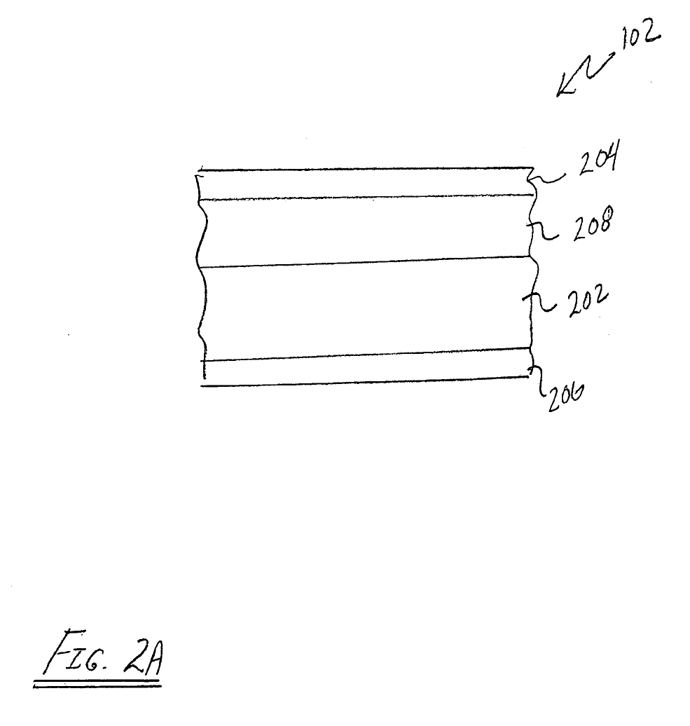

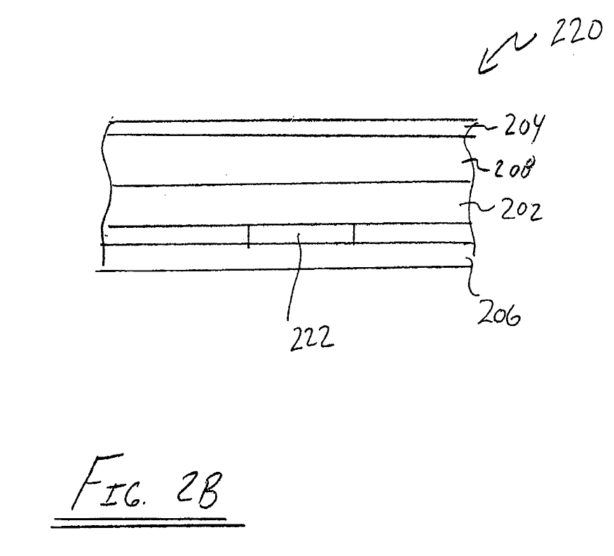

FIG. 1 is a pictorial illustration of a therapeutic pressure application device 100 that includes a multi-layered inflatable wearable garment 102. FIG. 2A is a cross sectional illustration of the multilayered inflatable structure wearable garment 102. Referring to FIGS. 1 and 2A, the wearable garment 102 includes a support structure and a bladder secured to the support structure. In the embodiment illustrated, the support structure includes fabric layers and the bladder is secured to the support structure by sewing fabric layers together with the bladder between the layers. Accordingly, FIG. 2A illustrates a bladder 202 sandwiched between a first fabric layer 204 and second fabric layer 206. Though, it should be appreciated that the support structure may be made of any suitable material and the bladder may be secured to the support structure in any suitable way, including with a securing mechanism that allows the bladder to be removed.

For comfort of the wearer a thin layer of foam 208, or other comfort/padding material, may be located between the first fabric layer 204 and the air bladder 202. The foam may include for example low, medium or high density foam, and may have a thickness of about 0.125 to 1 inch. It is contemplated that padding materials other than foam may also be used to provide the desired comfort. The thickness of the foam/padding material may not be uniform.

The pressure application device 100 also includes a plurality of cooperating male connector components 112-114 and cooperating female connector components 116-118, respectively, to secure the pressure application device 100 over the shoulders and around the upper body/torso of the wearer.

Pressure on a wearer may be generated by filling the bladder with a fluid. The fluid may be a liquid or gaseous medium. In the embodiment illustrated, that fluid may be air.

However, according to some embodiments, multiple mechanisms may be used to generate pressure on a wearer of a therapeutic device. In the embodiment illustrated, three mechanisms for generating pressure on a wearer are included.

In addition to generating pressure by filling the bladder, pressure may be generated by attaching weights to the support structure. FIG. 1B illustrates an exemplary approach for attaching weights. In the embodiment of FIG. 1B, a holder 111 is attached to the support structure. A weight may be placed within the holder.

Though not expressly illustrated in FIG. 1B, holder 111 may be a lockable pouch or other device that precludes access to the weight in holder 111 by a wearer of the therapeutic device. Holder 111 may be made lockable in any suitable way, including by use of a zipper or fastener that includes a locking mechanism.

It should be appreciated that FIG. 1B illustrates an exemplary attachment mechanism for a weight and other attachment mechanisms are possible. For example, holder 111 need not be fixedly attached to the support structure. A separable mechanical connector, such as may be provided through the use of hook-and-loop fasteners, may be employed to attach holder 111 to the support structure. In other embodiments, a weight may be attached to the support structure without the use of an intermediate holder. For example, a hook-and-loop fastener system may be employed to attach the weight directly to the support structure.

Regardless of how the weights are attached, the attachment mechanisms for the weights may be positioned to provide a generally balanced force on the wearer of therapeutic device 100. Accordingly, FIG. 1A illustrates an embodiment in which four attachment locations for weights are provided. As can be seen in FIG. 1A, these attachment locations are positioned generally symmetrically on each side of the therapeutic device 100. Additionally, the holders, such as holder 111, are positioned such that when a portion of therapeutic device 100 is draped over the shoulder of a wearer, holders will be both on the front and back sides of the wearer. However, it should be appreciated that any suitable placement of holders for weights may be employed.

FIG. 1A also illustrates a third mechanism for applying pressure to a wearer. As illustrated, connector components 112-114 and 116-118 are attached to the ends of straps. These straps may be of adjustable length. By tightening the straps, pressure may be applied to the wearer of device 100. It will be appreciated that strap material(s), structure and dimensions may be specified to achieve any of a variety of desired functional, aesthetic, or physical characteristics, e.g., a desired elasticity. Accordingly, straps may be produced using any of a variety of materials including, for example, neoprene, woven nylon, spandex, cotton, canvas, etc.

The air bladder 202 may be a unitary structure as illustrated in FIG. 1A, or may comprise a plurality of air bladder segments to facilitate comfort. For example, using segmented air bladders within the multi-layered inflatable wearable garment 102, air bladders segments may be located adjacent to the torso of a wearer, as well as adjacent to the top of the shoulder blade area of a wearer. When inflated the air bladder may have a nominal thickness of about for example ¼ to 2 inches to provide the applied pressure, and provide pressure sufficient to ensure that the wearer receives the desired therapeutic sensation (e.g., a simulated hug). In the deflated state the airbladder may have a thickness of about for example ⅛ inch. It is also contemplated that the air bladder segments may have different nominal inflated thickness dependent upon the location of the segment. The air bladder material is preferably plastic, but one of ordinary skill will recognize that other materials may also be used.

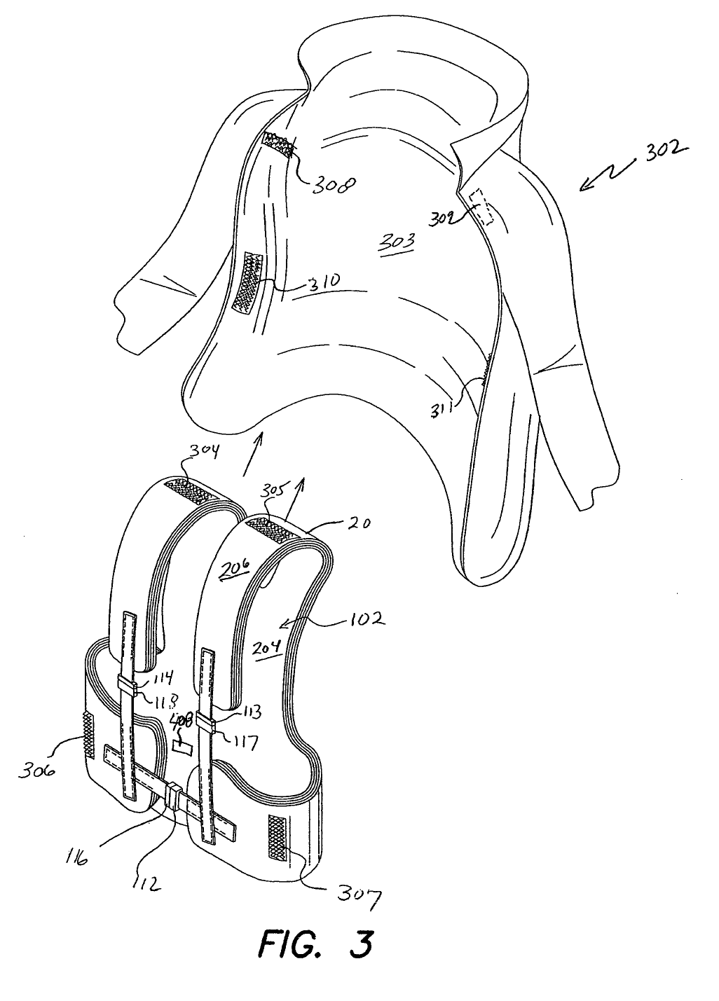

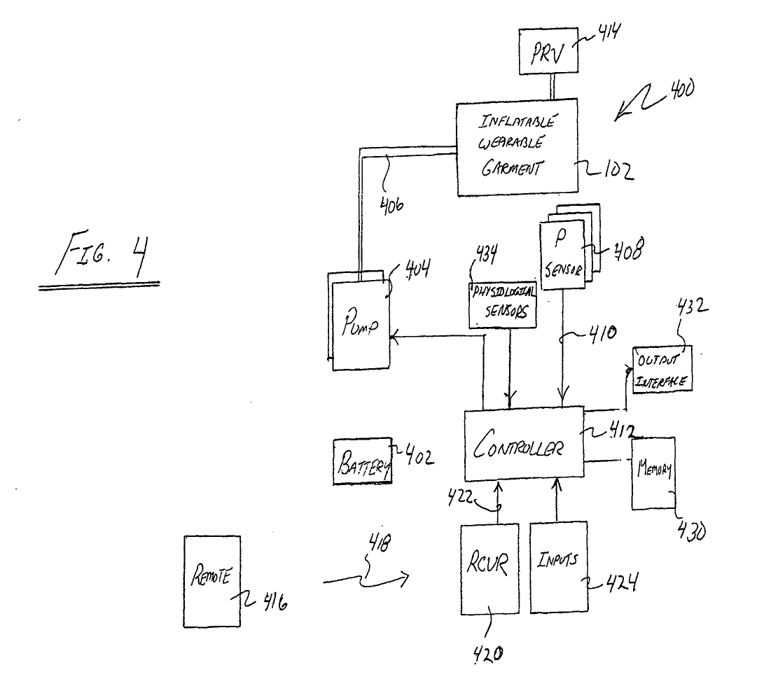

FIG. 3 is a pictorial illustration of how the therapeutic pressure application device 100 is removably and replaceably mounted within a jacket 302. The second fabric layer 206 of the wearable garment 102, when secured to the jacket 302, is positioned adjacent to an interior surface 303 of the jacket. The first and second fabric layers 204, 206 may be selected from materials such as cotton, flannel, synthetic materials such as SPANDEX™ material, or other wearable clothing fabric. The inflatable wearable garment 102 may also include hook fasteners 304-307 that cooperate with corresponding loop fasteners 308-311, respectively to secure the garment 102 to the jacket 302. The fasteners may be VELCRO® hook and loops fasteners. One of ordinary skill in the art will recognize that other fasteners, such as for example, zippers, buttons, et cetera may be used to removably and replaceably secure the inflatable wearable garment 102 to the jacket 302.

In some embodiments, deep pressure touch simulation is applied to a wearer of the therapeutic device by pressurizing the bladder. The bladder may be pressurized through the use of a pump. In some embodiments, the pump may be manually operated. Though, in other embodiments, the pump may be motorized and powered from a battery or other power source in order to allow the pressure to be supplied without manual operation of the pump.

In embodiments in which the pump is motorized, a controller may be included to provide control signals to turn the pump on or off A controller may employ any suitable control algorithms. The controller, for example, may be fully automatic, operating under program control in response to sensory inputs as described in greater detail below. In other embodiments, the controller may respond partially or solely to command inputs provided by a person, whether an individual wearing the device or another person, such as a caregiver. In embodiments in which the controller receives command inputs, those inputs may be received wirelessly, such as from a remote control, or may be received through a wired connection from a user interface element. The user interface element may include one or more switches, which could be attached to the device itself or may be attached to a pendant connected to the device through a wire, such that command inputs are generate by activating a switch.

In embodiments in which the controller is fully automatic, the controller may include a processor, such as a microprocessor or a microcontroller, that executes a control algorithm encoded in software. In embodiments in which the controller receives command inputs, the controller may include a processor to convert the command inputs into control inputs to the pump based on values output by one or more sensor or other parameters. Though, in some embodiments, the controller may simply convert the command inputs into signals of the appropriate level to turn on or off the pump in accordance with the command inputs. In some embodiments, the controller may simply route the command inputs directly to the control inputs of the pump.

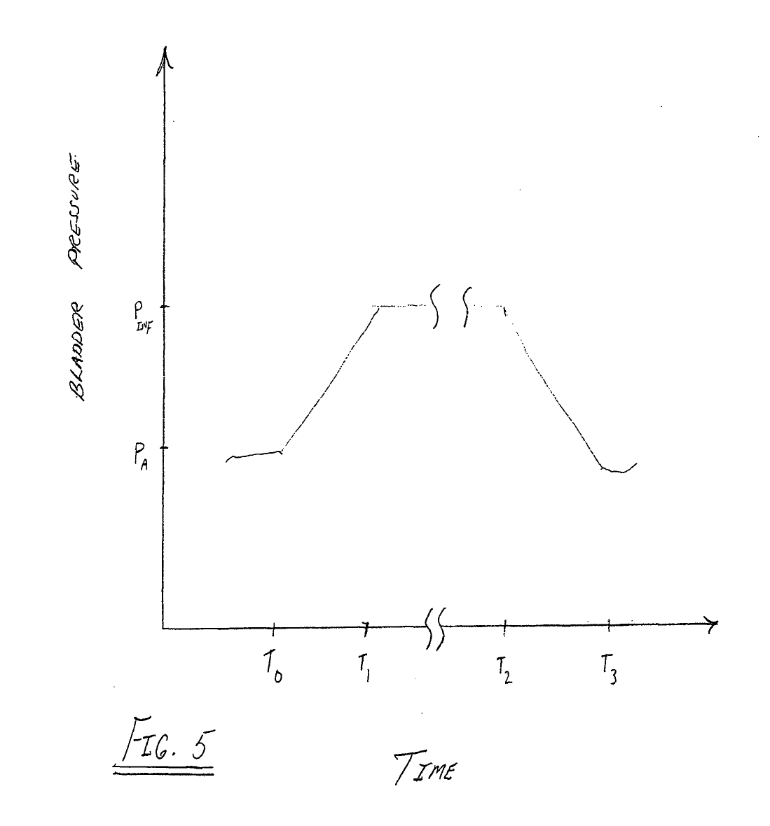

FIG. 4 is a system block diagram of an embodiment in which a processor-based controller is included. FIG. 4 shows the pneumatic and electronics systems 400 of the therapeutic pressure application device 100. A battery 402 (e.g., rechargeable) provides power to an electric air pump 404 that provides air along a flow line 406 to the inflatable wearable garment 102.

In the embodiment illustrated, pressure may be controlled bother by either adding or releasing air from the bladder. The pump 404 may include a check valve (not shown) that when open allows air to be discharged from the inflatable wearable garment 102 to ambient, and when closed allows air to flow only from the pump to the inflatable wearable garment 102. The pump is preferably reversible to remove air from the garment (i.e., deflate the garment). In another embodiment a first pump may be used to the inflate, and a second pump may be used to deflate.

In some embodiments, the controller may be programmed to generate commands to add or release air from the bladder based at least in part on pressure parameters measured by one or more sensors. Referring to FIGS. 3 and 4, a pressure sensor 408 located adjacent to the first fabric layer 204 senses pressure applied by the inflatable wearable garment 102 against the torso of the wearer, and provides a pressure signal indicative thereof on a line 410 to a controller 412. Rather than a single sensor, it is contemplated that a plurality of pressure sensors may be used to sense the applied pressure at different locations of the inflatable wearable garment. The controller 412 may include a processor (e.g., a DSP, a microprocessor, a microcontroller, a state machine, et cetera) that controls the pump. The system 400 may also include a pressure release valve (PRV) 414 that releases air from the air bladder 202 in the event the air pressure within the bladder exceeds a threshold value (e.g., 3 psi above ambient).

The pneumatic and electronics system 400 may also include a remote control 416 that provides an electromagnetic signal 418 to a receiver 420, which provides received control signals on a line 422 to the controller 412. The electromagnetic signal may be an RF (e.g., a BLUETOOTH® signal) or IR signal. The system may also include a plurality of input devices 424 such as an on/off switch, an inflate switch, a deflate switch and a switch that controls the timing of the inflate/deflate sequence. The user may manually initiate inflation and deflation via the inflate and deflate switches, respectively, thus allowing the user to manually select the desired applied pressure.

In addition to controlling the pump 404 based upon applied pressure, it is contemplated that the controller 412 may receive various other signals and control the pressure applied to a wearer of the device based on one or more of these signals. Such signals may be indicative of physiological conditions of the wearer of the device. Such sensors, for example, may provide to the controller a heart rate signal, a muscle tension signal and/or a galvanic skin response (GSR) signal. These physiological signals may be used to detect when inflation/deflation of the wearable garment 102 is desirable to provide the desired therapeutic applied pressure to the wearer. As one example, sensor values indicating that the wearer is stressed may trigger the controller to implement a control routine that applies pressure in a predetermined profile or a dynamically derived profile based on changes in the sensor values to provide deep pressure touch simulation.

Alternatively or additionally, the sensors may output parameter values indicative of a perceivable condition. The perceivable condition may relate to an individual wearing the device or may relate to the environment in which the individual is present. These sensors may output values indicating bio-mechanics of the wearer of the device. As an example of sensors indicating a perceivable condition relating to bio-mechanics of the wearer, one or more accelerometers may be attached to the device or may be electronically coupled to the device. An accelerometer signal may be indicative of fidgeting, flapping or other motion that may indicate that the wearer is under stress, and may trigger the controller to apply pressure in accordance with a pressure profile.

In some embodiments, some or all of the sensors will be secured to the device. Though, in some embodiments, at least some of the sensors may not be secured to the device, but may be operatively connected to the controller of the device. For example, in some embodiments, the device will be worn as a vest on the torso of an individual, and accelerometers will be attached to body parts of the wearer other than the torso. For example, accelerometers may be attached to the shoes or on bands around the arm of the wearer. The accelerometers may be operatively coupled to a controller through wired or wireless links.

Examples of other sensors that may output signals indicative of a perceivable condition include acoustic sensors and video sensors. The output of the acoustic sensor, for example, may be coupled through a voice detection circuit such that it provides a signal indicative of a level and/or nature of utterances being made by the wearer of the device. Detection of utterances indicative of an agitated state of the wearer may trigger the controller to provide a pressure in accordance with a pressure profile that provides deep pressure touch simulation. As an other example, a sensor may capture a visible image of the wearer, which may be coupled through a image analysis component to detect whether the wearer has an agitated facial expression, which may again be a trigger. A sensor that captures video images may be captured through a video analysis component to detect flailing or other motions indicative of agitation. In response, the controller may apply a pressure profile.

In some embodiments, sensors detecting a perceivable condition may output parameters indicative of the environment in which the user is wearing the device. Outputs of these sensors may be processed to detect conditions likely to create stress on the wearer of the device of other conditions in which the wearer would benefit from deep pressure touch simulation. Acoustic sensors and images sensors, for example, may alternatively or additionally capture utterances, facial expressions or movement of people in the vicinity of the wearer of the device. A person in the vicinity of a wearer of the device looking angry or yelling may trigger the device to apply deep pressure touch simulation. As another example, analysis of sound, images or other sensor output may indicate that the wearer of the device is in a crowded room.

Though, the sensors may not be limited to characteristics of other people. Some individuals are known to become excited in response to loud noises, noise made by hair dryers or other stimulation. A system including a device as described herein could be coupled to sensors that indicate such environmental conditions and, in anticipation of the wearer becoming agitated, apply deep pressure touch simulation.

In some embodiments, the controller may be programmable so as to allow different triggers for different wearers. For example, while anxiety or stress may be triggered in some wearers by loud noises, anxiety may be triggered in other wearers, for example people with claustrophobia, upon entering a confined space. Accordingly, a device may be programmed to pressurize and depressurize a bladder to provide deep pressure touch simulation in response to detection of perceivable conditions selected based on the sensitivities of an intended wearer of the device.

Sensors that indicate perceivable conditions that may trigger deep pressure touch simulation may be secured to the device. Though, the sensors may be mounted external to the device. In embodiments in which the device is worn in a controlled environment, some or all of the sensors may be mounted in the environment. Likewise, processing of sensor outputs to determine whether to apply deep pressure touch simulation or parameters of that simulation, such as a pressure profile, may be performed in a processor secured to the device or in a processor external to the device. As one example, a classroom may contain a camera, a microphone, a processor and a wireless controller. The processor may process outputs from the camera, acting as a video sensor, and the microphone, acting as an acoustic sensor, to detect an overall activity level that may create stress on a wearer of the device. Upon detection of such a condition, the processor may trigger the wireless controller to send signals wireless to the device to apply deep pressure touch simulation.

When components, such as sensors, are secured to the device, they may be secured in any suitable way. In some embodiments, the components are secured in a way that allows the components to be removed after they have been secured or allows a device to be assembled in multiple different configurations, using components of different types. Such removable connections may include separable mechanical attachments as well as separable operative connections. For sensors, the operative connections may be electrical and made through separable electrical connections. For other electronic components, separable electrical connectors also may be used. For other types of components, such as a pump, separable fluid connectors may be employed to operatively connect the components.

Any suitable form of separable mechanical attachment may be used. In some embodiments, components may be secured directly to the support structure. For example, a hook and loop mechanical connector, such as may be provided using VELCRO® fasteners may be employed. Though, other forms of mechanical connectors, such as snaps, zippers, buckles or buttons may be used.

In some embodiments, components may be secured to a support structure of the device using an indirect form or attachment. For example, the components may be placed inside a holder, such as a sealed pouch, which is in turn secured to the support structure. The holder may be secured to the support structure through a separable mechanical attachment or may be secured with a more permanent attachment mechanism, such as stitching.

In some embodiments, components may be secured the device in such a way that a wearer of the device is prevented from accessing those components. In some embodiments, the components may be locked within a holder. Separable connectors by which those components are connected to the system may also be protected from access by positioning those components within the holder.

In some embodiments, components are secured within a lockable pouch. The pouch may be fixed to the support structure of the device or may be removable. In some embodiments, the pouch may be removed, even though in a locked state.

As an example, referring to FIG. 1, the device 100 also includes a lockable pouch 110 that is removably and replaceably attached to the wearable garment 102. For example, as shown in FIG. 1 the lockable pouch 110 may include a first buckle 120 and a second buckle (not shown) that secure the pouch 110 to the wearable garment 102. One of ordinary skill will recognize that a number of fastening techniques may be used to removably and replaceably secure the pouch 110. For example, a hook-and-loop fastener(s), a zipper(s), buttons, et cetera may be used.

The pouch 110 may include the pneumatic and electronics system 400 components that control the inflation and deflation of the inflatable wearable garment. As a result, referring to FIG. 4, a user may disconnect the flow lines 406 from the inflatable wearable garment 102 and then detach the pouch 110 from the wearable garment 102.

The therapeutic pressure application device 100 may also include a second pouch 122, available for example for additional storage. The second pouch may also be removably and replaceably secured.

In addition to simply inflating the garment 102 to a nominal applied pressure, the system may allow the user to select from various selectable pressure profiles/cycles. For example, the user may select from a pressure profile as illustrated in FIG. 5. FIG. 5 illustrates a plot of applied pressure versus time. At time T₀ the pump starts inflating the bladder and at time T₁ the desired applied pressure PA is achieved. The applied pressure remains until time T₂, when air within the bladder is discharged to ambient, thus returning the applied pressure to its nominal deflated value at time T₃. The various pressure profiles may be stored in the controller 412 (FIG. 4), which preferably includes internal non-volatile memory or employs a non-volatile memory device external to the controller for storing an executable control routine and the selectable pressure profiles. The controller 412 modulates the applied pressure/air pressure within the air bladder to achieve the selected therapeutic pressure profile.

Referring again to FIG. 4, the controller 412 may also monitor and record readings from various physiological sensors 434 (e.g., a heart rate sensor, an accelerometer, a muscle tension sensor, galvanic skin response sensor, et cetera) and record the results in a memory device 430. The recorded information may be downloaded via a wireline or wireless output interface 432 to provide information to facilitate providing the most effective therapeutic applied pressure to the individual wearer.

FIG. 2B is a cross sectional illustration of an alternative embodiment multi-layered inflatable wearable garment 220. In this embodiment a pressure sensor 222 (e.g., piezoelectric, strain gauge, et cetera) may be sandwiched within the multi-layered structure to sense applied pressure and provide a signal indicative thereof to the controller. It is contemplated that a plurality of pressure sensors may be distributed within the garment 220 to sense applied pressure at different locations.

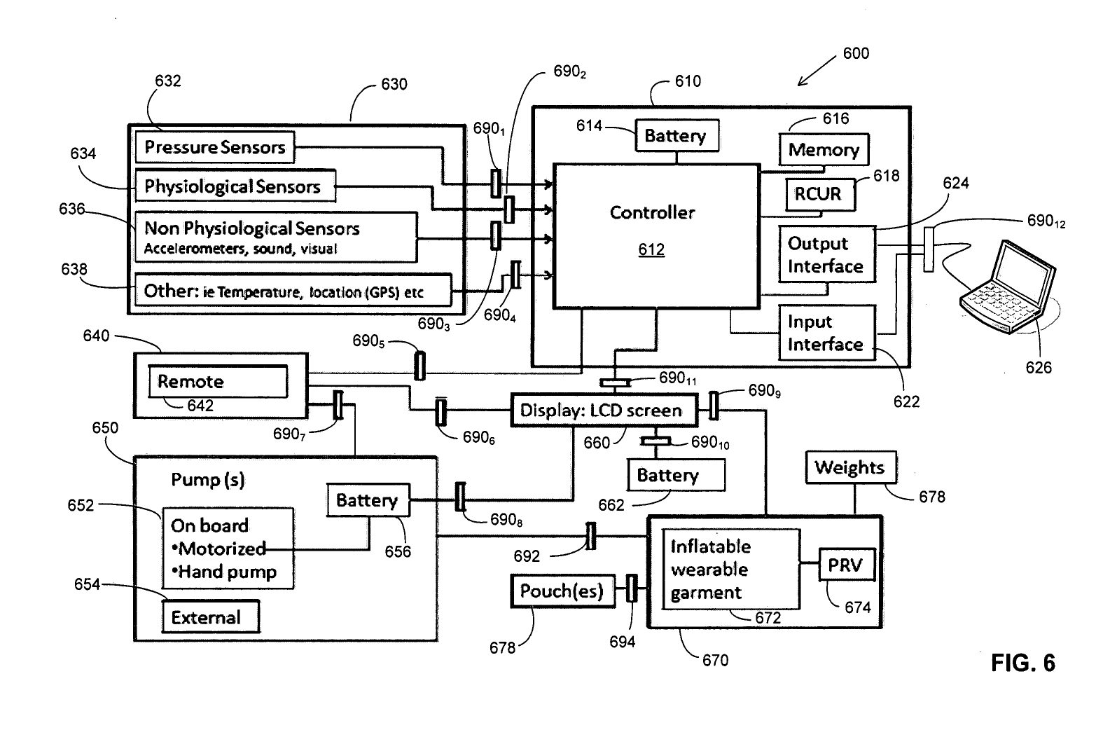

As described above, a therapeutic pressure application device according to some embodiments may employ modular components that are interconnected through separable connections. Such a design allows manufacture of therapeutic devices tailored to individual wearers suffering from any of a number of conditions for which deep pressure touch simulation may be beneficial. FIG. 6 illustrates an exemplary embodiment of a therapeutic system 600 in which modular components are interconnected into a therapeutic device. FIG. 6 illustrates that the therapeutic system 600 may contain multiple segments, including a controller segment 610, a sensor segment 630, a command segment 640, a pump segment 650, a display segment 660, and a garment segment 670. Each of these segments may contain one or more modular components that are interconnected through the use of separable connectors or in any other suitable way. For example, as described above, it is not necessary for all of the sensors in sensor segment 630 to be secured to a wearable therapeutic device. One or more of the sensors in sensor segment 630 may be outside the therapeutic device and coupled to it through a wireless connection or other suitable form of interface. Likewise, some control functions, such as programming pressure profiles, may be controlled through a computer 626, which may also be external to the therapeutic device. In the embodiment illustrated, control segment 610 includes a controller 612. Controller 612 may be a microprocessor, microcontroller, or other suitable processor. Though, it should be appreciated that controller 612 may be simple signal conditioning circuitry that applies appropriate control signals in response to commands received. However, in the embodiment illustrated, controller 612 is coupled to a memory 616. Memory 616 may be any suitable computer memory and may store both data and program code. The program code stored in memory 616 may be executed by controller 612 to perform control functions as described herein. The data in memory 616 may represent pressure profiles or trigger conditions that initiate application of a pressure profile. The data may be customized for a wearer of a therapeutic device including control segment 610.

To facilitate customized programming of control segment 610, an input interface 622 and an output interface 624 may be included. In the embodiment illustrated, input interface 622 and output interface 624 may be coupled to an external computing device, such as computer 626 through a separable connector 690₁₂. However, any suitable mechanism for supplying programs and/or data for use in controlling a therapeutic device may be provided. Also, it is not a requirement that control information, such as programs and data, be supplied through a wired interface. As shown, control segment 610 may include a wireless receiver 618. In some embodiments, an external device may provide programming and/or data through a wireless receiver 618.

As shown, control segment 610 includes a battery 614 to power the components of control segment 610. In the embodiment illustrated, each of the segments of the therapeutic system 600 may contain its own power source. However, it should be appreciated that one or more components may share a power source.

The program stored in memory 616, when executed by controller 612, may determine that a trigger condition has been satisfied such that deep pressure touch simulation should be applied to the wearer of the therapeutic device. A trigger condition may be detected based on outputs from one or more sensors within sensor segment 630. Any suitable number and type of sensors may be incorporated into sensor segment 630. FIG. 6 illustrates pressure sensors 632, physiological sensors 634, non physiological sensors 636, e.g., perceivable condition sensors, and other sensors 638. These sensors may be positioned in suitable locations to measure parameters used in determining whether to apply a deep pressure touch simulation or controlling components in other segments to apply an appropriate pressure. For example, pressure sensors 632 may be attached to a support structure of a wearable therapeutic device using a mechanism that positions the pressure sensors 632 between an inflatable bladder and a wearer. Physiological sensors 634 may likewise be attached to a support structure such that they may sense physiological conditions of the wearer. Non-physiological sensors 636 may be attached to the wearable device or may be located in an environment in which the device may be worn. Likewise, other sensors 638 may be attached to the device or positioned in the environment. In some embodiments, the physiological sensors, non-physiological sensors, or other sensors may be attached directly to the wearer of the therapeutic device, e.g., worn on the wearer's wrist, independent of the support structure of the device. Non-physiological sensors 636 and other sensors 638 may output parameters indicating perceivable conditions indicating that the wearer of the therapeutic device is stressed or is in a situation that may lead to stress.

Depending on the condition of the wearer of the device, some or all of the sensors within sensor segment 630 may be useful in controlling a therapeutic device for an individual. Accordingly, FIG. 6 illustrates that each type of sensor, pressure sensor 632, physiological sensor 634, non-physiological sensor 636, and other sensors 638, is coupled to control segment 610 through separable connectors. In the embodiment illustrated, each of the types of sensors outputs values as electrical signals. Accordingly, the coupling to control segment 610 is through separable electrical connectors 690₁, 690₂, 690₃, and 690₄. Though, as noted above, any suitable form of coupling may be used, including wireless coupling between the sensors and the control segment 610. Though, because the individual sensors are joined through separable connectors, some or all of the sensors may be omitted in some embodiments, depending on the control program loaded in memory 616 for an individual wearer of the therapeutic device.

FIG. 6 also illustrates an interface segment 640. In this example, the command interface 640 is also wired to other segments of the therapeutic system through separable electrical connectors. Such configuration may be useful when a pendant or similar remote unit 642 is used for providing commands to activate the therapeutic device. In the embodiment illustrated, remote command unit 642 is coupled to other segments through separable electrical connectors, illustrated as separable electrical connectors 690₅, 690₆, and 690₇. In this example, electrical connector 690₅ makes connections between remote command unit 642 and controller 612 such that signals, representing commands input at remote command unit 642, may be coupled to controller 612. Connector 690₆ may couple remote command unit 642 to a display segment 660, such that a clinician or other person operating remote command unit 642 may receive feedback indicating command inputs entered through remote command unit 642. Remote command unit 642 may be coupled to another segment, here shown as being coupled to pump segment 650, from which remote command unit 642 may receive power. As with the sensors in sensor segment 630, remote command unit 642 may be omitted in some embodiments.

FIG. 6 also shows a pump segment 650. Pump segment 650 may include a pump 652, which may be secured to a support structure of the wearable therapeutic device. Pump 652 may be any suitable type of pump, including a motorized or a hand pump. In embodiments in which pump 652 is motorized, pump segment 650 may include a battery 656 to power the motorized pump. In such an embodiment, battery 656 may be coupled directly to a motorized pump 652. Though, in some embodiments, battery 656 may be coupled to motorized pump 652 through a separable electrical connector.

Pump segment 650 may alternatively or additionally include one or more external pumps.

In embodiments in which pump segment 650 includes one or more motorized pumps, an electrical connection between control segment 610 and pump segment 650 may be provided so that control signals generated within control segment 610 may be coupled to the pump to control its operation. In the embodiment illustrated in FIG. 6, the control path between control segment 610 and pump segment 650 passes through remote command segment 640, including passing through separable electrical connectors 690₅ and 690₇. Though, it should be appreciated that other connection paths may be employed, including a direct connection between control segment 610 and pump segment 650.

Regardless of the type of pump or pumps included in pump segment 650, a fluid connection may be supplied between a fluid outlet of the pump and a bladder that is inflated and/or deflated by operation of the pump. Accordingly, FIG. 6 shows a separable fluid connection 692 between pump segment 650 and pressure application segment 670. Pressure application segment 670 includes a bladder 674 attached to a support structure 672. When a pump within pump segment 650 pumps fluid through a fluid outlet of the pump through fluid connector 692, it will increase the pressure within bladder 674, creating the sensation of touch to the wearer of the device. Likewise, one or more pumps within pump segment 650 may be controlled to decrease the pressure within bladder 674. In the embodiment illustrated, the same fluid coupling may be used to increase or decrease the pressure within bladder 674, However, any number of couplings may be supplied and those fluid couplings may be employed to increase or decrease pressure to the bladder 674.

Pressure application segment 670 is also illustrated with weights 680 to provide an additional mechanism for applying pressure to a wearer of the therapeutic device. Weights 680 may be attached to components of the pressure application segment 670 through a fixed connection or through a separable mechanical connection, as described above. Additionally, one or more pouches 678 may be applied through a separable mechanical connection 694. The pouches 678 may store one or more components of the therapeutic system or, more generally, may be provided for additional storage, allowing the therapeutic device to function as a backpack.

FIG. 6 also illustrates that other segments may, in some embodiments, be included in a therapeutic system. In the embodiment illustrated, a display segment 660 is incorporated. In this example, display segment 660 includes an LCD screen that is coupled to control segment 610 through a separable electrical connector 690₁₁, A separate battery 662 may be provided to power display segment 660. In this example, display segment 660 is coupled to battery 662 through a separable electrical connector 690₁₀. Display segment 660 may receive inputs from one or more of the other segments and provide output to a clinician, a wearer of the therapeutic device, or other person controlling the device. Accordingly, FIG. 6 illustrates separable connections to other segments, including a connection to control segment 610 through separable connector 690₁₁, a separable connection to command segment 640 through connector 690₆, a connection to pump segment 650 through connector 690₈, and a connection to the wearable garment through connector 690₉, which may be an electrical or mechanical coupling.

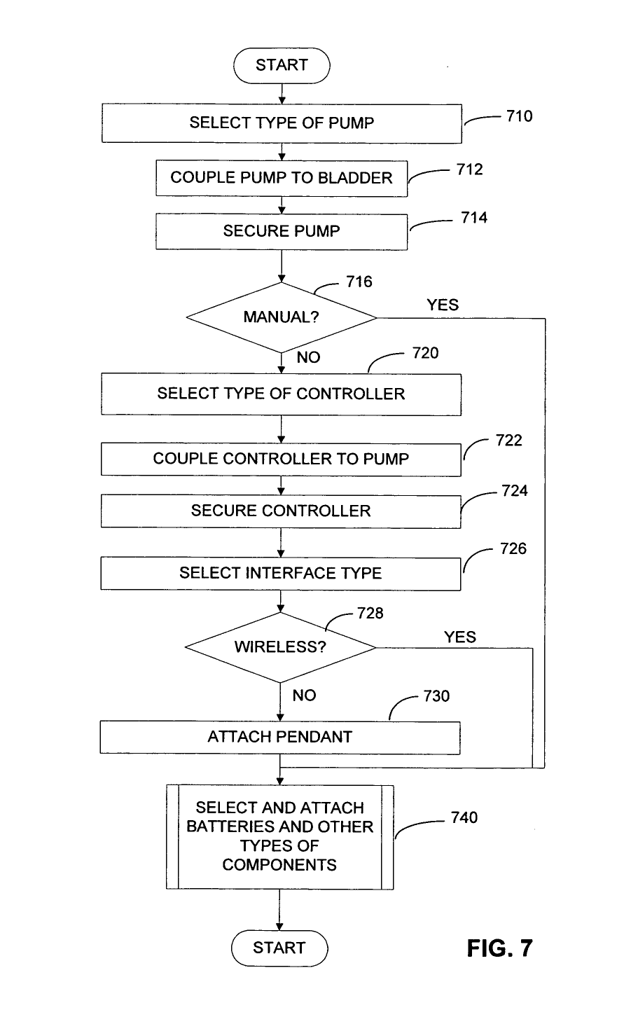

FIG. 6 illustrates that a therapeutic system may be constructed using various modules interconnected by separable connectors. Such an architecture allows a device to be configured for an individual user. FIG. 7 illustrates a method of manufacturing a therapeutic device configured for a user. The method of FIG. 7 may be performed at the time a therapeutic device is initially constructed, or at anytime thereafter at which the therapeutic device is reconfigured for different individual wearers.

The method of FIG. 7 starts at block 710 where a type of pump is selected. For example, a selection may be made to use an onboard pump or to use an external pump. If an onboard pump is selected, a selection may be made to use a motorized pump or to use a hand pump. The type of pump selected at block 710 may be dictated by the intended use of the therapeutic device.

Regardless of the type of the pump selected at block 710, a specific pump of the selected type may be obtained at installed. At block 712, a pump of the selected type is coupled to a bladder to form a portion of the therapeutic device. At block 712, an output port of the pump may be coupled to an inlet port of the bladder through a separable fluid connector.

Once the pump is coupled to the bladder, the pump may be secured to a support structure of the therapeutic device. Step 714 may be an optional step, performed when the selected pump type is an onboard pump.

The process then branches at decision block 716 if the selected pump type is motorized, processing may proceed to block 720. In contrast, if the selected pump type is manual, the process may branch from decision block 716 to 740, omitting process steps applicable to configuring a device using a motorized pump.

If the selected pump is not manual, the process may proceed to block 720 where a type of controller is selected. The type of controller may depend on the type or nature of command inputs to the device. In embodiments in which command inputs may be provided by activation of switches, a type of controller may be selected at block 720 to provide simple control. In other embodiments in which command inputs are provided wirelessly, the type of controller selected at block 720 may include a wireless receiver. Regardless of the type of controller selected at block 720, the processes proceeds to block 722 where a controller of the selected type is obtained and may be installed in the therapeutic device. At block 722, the selected controller is coupled to the pump, such that the controller may provide control signals to the pump, such that the controller may provide control signals to the pump. The coupling may be through a separable electrical connector.

Once the controller is coupled to the pump, the controller may be secured to the therapeutic device. Any suitable mechanism to secure the controller may be employed, including placing the controller in a lockable pouch and then locking the pouch.

The process may then continue at block 726 where an interface type is selected. As an example, a wireless interface or a pendant interface may be selected, though any suitable type of interface may be selected at block 726. The process then branches at decision block 728, depending on the type of interface selected. If the interface is wireless, the process may branch to block 740, skipping block 730. In contrast, if the selected interface type is not wireless, the process may proceed to block 730 where a command interface may be provided, for example, a pendant may be selected and coupled to one or more segments of the therapeutic device, such as the control segment. However, any suitable form of electrical or mechanical attachment may be employed at block 730. The process may then continue to process block 740. At processes block 740, any one or more types of modular components may be selected and specific components of these types may be mechanically and/or operatively connected to other modular components of the system through separable connections. For example, batteries may be selected and coupled to other components of the system. Though, one of skill in the art will appreciate that the assembly of a device may involve selecting and attaching any number of components.

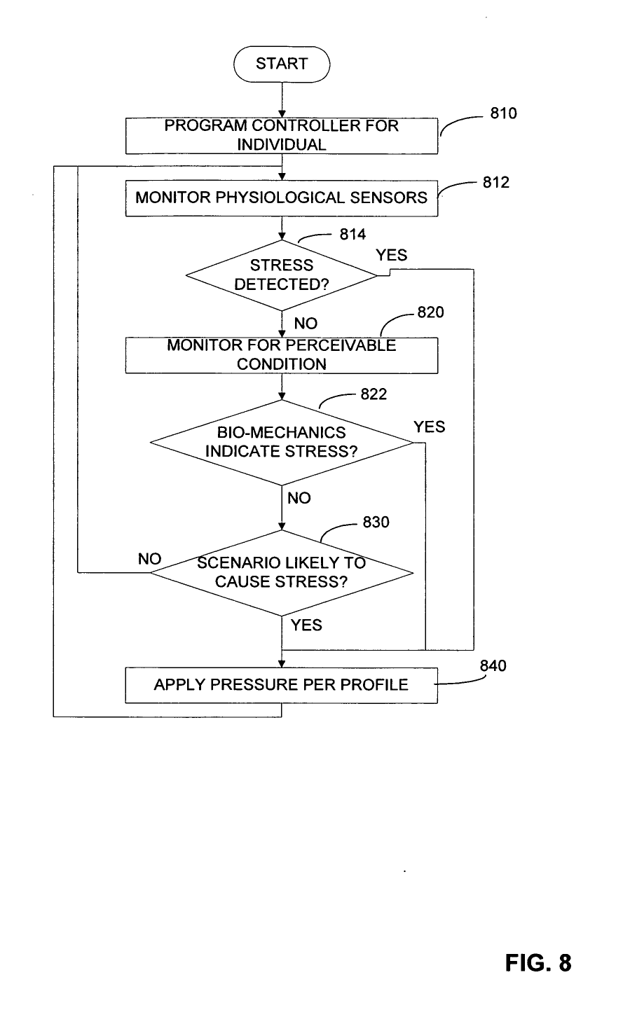

Regardless of the number and types of components that are selected and interconnected to form a therapeutic system, the system may be operated to provided deep pressure touch simulation to an individual wearing the device. FIG. 8 illustrates a method of operating such a device. The process of FIG. 8 starts at block 810 where a controller is programmed for an individual user. Such programming may be performed in any suitable way, including loading program code, pressure profiles, indications of preloaded pressure profiles, loading trigger values or other parameters that may specify operation of the therapeutic device. For a system as illustrated in FIG. 6, programming at block 810 may be performed from an external computer, such as computer 626 coupled to controller segment 610 in any suitable way. The programming information may be loaded into memory 616 or captured in any suitable way.

Regardless of the manner in which programming is achieved, the process may continue to block 812. At block 812, outputs of physiological sensors may be monitored. In the embodiment of FIG. 6, this monitoring may be performed by operation of controller 612. However, the monitoring may be achieved in any suitable way and may be controlled by any suitable component. As an example of one possible alternative, the monitoring may be performed by a remote computer wirelessly coupled to control segment 610.

Regardless of where and how the monitoring is performed, the process may branch at decision block 814 if the outputs of the physiological sensors indicate that a wearer of the device is under stress. When such stress is detected, the process may branch from decision block 814 to block 840.

At block 840, the device may be controlled to apply a pressure profile. The pressure profile may be the profile programmed for the individual at block 810 or may be determined in any other suitable way. As an example of one alternative, the pressure profile may be dynamically determined based on a level of stress detected at block 814.

Regardless of the nature of the pressure profile to be applied block 840, the pressure profile may be generated by controlling a pump to inflate and/or deflate a bladder in the therapeutic device. The pump may be operated to increase and decrease the pressure to generate a desired pressure profile. After the pressure profile is applied, the process may loop back to block 812 where the physiological sensors may again be monitored.

Even if stress is not detected at decision block 814, the process may proceed to block 820. Block 820 outputs of one or more sensors may be monitored to detect a perceivable condition associated with the wearer or the wearers environment. Based on this monitoring, the process may again branch. At decision block 822, the process may branch depending on whether the perceivable conditions reveal biomechanics of the wearer that indicate the wearer is under stress. Such biomechanics may be fidgeting or other actions. If such biomechanics indicate stress, the process may branch to block 840 where a pressure profile may be applied. The pressure profile applied at block 840 may be the same profile applied when stress is detected at decision block 814. However, different pressure profiles may be applied, even to the same individual, in response to different trigger conditions. Accordingly, a different pressure profile may be applied when physiological sensors indicate stress than when biomechanics indicate stress.

In scenarios in which biomechanics do not indicate stress, the process may proceed to decision block 830. At decision block 830, the process may again branch depending on whether perceivable conditions indicate the wearer of the therapeutic device is in a scenario likely to cause stress. If so, the process may branch to block 840 where a pressure profile is applied. If not, the process may loop back to block 812 where monitoring may continue. As before, if the processing reaches block 840, one or more pumps may be controlled to inflate a bladder and provide a touch simulation to a wearer of the device. The pumps may be controlled according to the same pressure profile as is used if processing reaches block 840 from decision block 822 or 814. Alternatively, the pressure profile may be dynamically selected or, different pre-defined profiles may be applied at block 840, depending on the trigger for applying a pressure profile.

Although the present invention has been illustrated and described with respect to several preferred embodiments thereof, various changes, omissions and additions to the form and detail thereof, may be made therein, without departing from the spirit and scope of the invention.

In some aspects of the invention, a therapeutic pressure application device is provided. In some embodiments, the therapeutic pressure application device is a garment independent therapeutic pressure application device. In certain embodiments, the therapeutic pressure application device is a garment independent upper body therapeutic pressure application device.

In some embodiments, the therapeutic pressure application device comprises an air bladder having an opening through which air passes into and out of the bladder; a battery powered air pump that provides air to the pneumatic bladder though the opening and discharges air from the air bladder via the opening; a pressure sensor that senses air pressure within the air bladder and provides a pressure signal indicative thereof; a controller that receives the pressure signal and automatically controls the battery powered air pump to regulate air pressure; a lockable pouch that is removably and replaceably secured to the pressure application device; and means for removably and replaceably securing the air bladder to a garment.

In some embodiments, the therapeutic pressure application device comprises an air bladder having an opening through which air passes into and out of the bladder, and sandwiched between a first fabric layer and a second fabric layer; a battery powered air pump that provides air to the bladder though the opening and discharges air from the bladder via the opening; a pressure sensor that senses pressure applied by the air bladder and provides a pressure signal indicative thereof; a controller that receives the pressure signal and automatically controls the battery powered air pump to regulate the pressure applied by the air bladder; a lockable pouch that is removably and replaceably secured to the first fabric layer; and means for removably and replaceably securing the air bladder to a garment.

In some embodiments, the therapeutic pressure application device comprises an air bladder having an opening through which air passes into and out of the bladder; a battery powered air pump that provides air to the pneumatic bladder though the opening and discharges air from the air bladder via the opening; a controller that receives an inflate signal and controls the battery powered air pump to inflate the air bladder; a lockable pouch that is removably and replaceably secured to the pressure application device; and means for removably and replaceably securing the air bladder to a garment. In certain embodiments, the therapeutic pressure application device further comprises a wireless remote control that provides an electro-magnetic control signal; and an electro-magnetic receiver that receives the electro-magnetic control signal and provides a received control signal to the controller. In some embodiments, the electro-magnetic control signal is compatible with BLUETOOTH® wireless protocol.

In some embodiments, the therapeutic pressure application device comprises an air bladder having an opening through which air passes into and out of the bladder; a battery powered air pump that provides air to the pneumatic bladder though the opening and discharges air from the air bladder via the opening; a sensor that senses a physiological parameter of a person wearing the pressure application device and provides a physiological signal indicative thereof; a controller that receives the physiological signal and automatically controls the battery powered air pump; a lockable pouch that is removably and replaceably secured to the pressure application device; and means for removably and replaceably securing the air bladder to a garment.

In some embodiments, the therapeutic pressure application device further comprises an input device (e.g., a controller input device) that provides a control signal indicative of a frequency at which to therapeutically modulate the pressure. In some embodiments, the controller modulates the air pressure within the air bladder. In some embodiments, the air bladder comprises a plurality of air bladder segments. In some embodiments, the therapeutic pressure application device further comprises a back pack, wherein the air bladder is attached to an interior surface of the back pack.

In some embodiments, the therapeutic pressure application device further comprises a battery that powers the electric pump, the controller and the pressure sensor. In some embodiments, the battery is rechargeable. In some embodiments, the electric air pump, the controller and the battery are located in the pouch. In some embodiments, the pouch is removably and replaceably attached to the air bladder with a hook-and-loop fastener. In some embodiments, the electric air pump, the controller and the battery may all be removably and replaceably disconnected from the air bladder.

In some embodiments of the therapeutic pressure application device, the means for removably and replaceably securing the air bladder to a garment comprises a hook side of a hook-and-loop fastener. In other embodiments of the therapeutic pressure application device, the means for removably and replaceably securing the air bladder to a garment comprises a loop side of a hook-and-loop fastener. In some embodiments of the therapeutic pressure application device, the means for removably and replaceably securing the air bladder to a garment secures the air bladder to an interior surface of the garment, such that the pressure application device it is not visible while being worn by a user.

The above-described embodiments of the present invention can be implemented in any of numerous ways. For example, the various methods or processes outlined herein may be coded as software that is executable on one or more processors that employ any one of a variety of operating systems or platforms. Such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A therapeutic pressure application device, comprising:
a support structure shaped to conform to a portion of a body of an individual;
a bladder having a port for the passage of a fluid, the bladder being supported by the support structure;
a first separable fluid connector coupled to the port;
a pump having a fluid outlet, the pump being secured to the support structure; and
a second separable fluid connector coupled to the fluid outlet of the pump, the second separable fluid connector being shaped to mate with the first separable fluid connector.

2. The therapeutic pressure application device of claim 1, wherein:
the device further comprises at least one lockable pouch secured to the support structure; and
the pump is housed in a pouch of the at least one lockable pouch.

3. The therapeutic pressure application device of claim 1, wherein:
the pump has a first electrical control input; and
the therapeutic pressure application device further comprises:
a controller comprising a first electrical control output, the controller being configured to generate an electrical control signal at the first electrical control output to automatically control the pump to regulate pressure in the bladder;
a first separable electrical connector, the first separable electrical connector coupled to the first electrical control input; and
a second separable electrical connector, the second separable electrical connector being shaped to mate with the first separable electrical connector, and the second separable electrical connector being coupled to the first electrical control output.

4. The therapeutic pressure application device of claim 3, wherein the controller is housed in a pouch of the at least one lockable pouches.

5. The therapeutic pressure application device of claim 4, wherein the pouch housing the controller is distinct from the pouch housing the pump.

6. The therapeutic pressure application device of claim 3, wherein the controller comprises a second electrical control input; and
the therapeutic pressure application device further comprises:
a pressure sensor attached to the support structure, the pressure sensor being configured to generate a signal indicative of a level of pressure at a second electrical control output, a third separable electrical connector coupled to the second electrical control output;
a fourth separable electrical connector, the fourth separable electrical connector being shaped to mate with the third separable electrical connector, and the fourth separable electrical connector being coupled to the second electrical control input.

7. The therapeutic pressure application device of claim 6, wherein:
the bladder comprises a wall; and
the pressure sensor comprises a measuring element associated with at least a portion of the wall of the bladder, the measuring element being configured to measure strain in the wall of the bladder.

8. The therapeutic pressure application device of claim 6, wherein:
the bladder comprises a wall; and
the pressure sensor comprises a measuring element associated with at least a portion of the wall of the bladder, the measuring element being configured to measure a force applied normal to the wall of the bladder.

9. The therapeutic pressure application device of claim 1, wherein the pump comprises a manually actuated pump.

10. The therapeutic pressure application device of claim 2, wherein the first separable fluid connector is disposed in the pouch housing the pump.

11. The therapeutic pressure application device of claim 1, wherein:
the portion of the body of the individual is a torso; and
the first separable fluid connector, the second separable fluid connector, and the first separable electrical connectors are disposed in the pouch housing the pump.

12. The therapeutic pressure application device of claim 3, further comprising:
a first battery coupled to supply power to the controller; and
a second battery coupled to supply power to the pump.

13. The therapeutic pressure application device of claim 1, further comprising:
at least one holder attached to the support structure; and
a weight in each of the at least one holders.

14. A method of manufacturing a therapeutic pressure application device, the method comprising:
selecting a type of pump;
selecting a pump of the selected type;
coupling a fluid outlet of the pump to a bladder secured to a support structure, the support structure being shaped to conform to a portion of a body of an individual; and
placing the pump within a lockable pouch secured to the support structure.

15. The method of claim 14, further comprising:
selecting a type of controller;
selecting a controller of the selected type;
connecting the selected controller to the selected pump;
connecting a first battery to the selected controller; and
connecting a second battery to the selected pump.

16. The method of claim 15, wherein:
selecting the type of controller comprises selecting between a first type of controller with a wireless control input and a second type of controller without a wireless control input.

17. The method of claim 16, further comprising:
selecting at least one pressure profile based on an intended wearer of the therapeutic pressure application device; and
programming a memory coupled to the controller with the at least one pressure profile.

18. A method of applying a deep pressure touch stimulation to an individual, the method comprising:
attaching a therapeutic pressure application device to a portion of a body of the individual, the therapeutic pressure application device comprising a bladder and a plurality of modular components interconnected through separable connections, the modular components comprising at least a pump and a controller, and
causing the controller to control the pump to regulate pressure in the bladder while the individual is wearing the device, thereby applying a deep pressure touch stimulation to the individual.

19. The method of claim 18, wherein:
causing the controller to control the pump comprises sending a control signal wirelessly to the controller from a location remote from the therapeutic pressure application device.

20. The method of claim 19, further comprising:
observing a behavior of the individual; and
generating the control signal based on the observed behavior.

21. The method of claim 18, further comprising:
securing weights to the support structure.

22. The method of claim 21, wherein securing the weights comprises inserting the weights into lockable holders.

23. The method of claim 18, wherein:
the therapeutic pressure application device comprises a plurality of straps; and
the method further comprises tightening the straps around a torso of the individual to augment the deep pressure touch stimulation to the individual.

24. A method of applying a deep pressure touch stimulation to an individual, the method comprising:
selecting a pressure profile;
attaching a therapeutic pressure application device to a portion of a body of the individual, the therapeutic pressure application device comprising a bladder, a pump and a controller, and
while the individual is wearing the device, with the controller, controlling the pump to regulate pressure in the bladder to apply a deep pressure touch stimulation to the individual in accordance with the selected pressure profile.

25. The method of claim 24, wherein:
the therapeutic pressure application device comprises a memory coupled to the controller; and
selecting the pressure profile comprises selecting the pressure profile from among a plurality of pressure profiles stored in the memory.

26. The method of claim 25, wherein:
the method further comprises determining at least one parameter characterizing a state of the individual; and
selecting the pressure profile from among the plurality of pressure profiles comprises selecting based on the at least one parameter.

27. The method of claim 24, wherein:
the therapeutic pressure application device comprises a memory coupled to the controller; and
selecting the pressure profile comprises downloading the pressure profile into the memory from an external device.

28. The method of claim 24, wherein:
the controller comprises a wireless receiver; and
controlling the pump to regulate pressure in the bladder comprises operating the controller in response to a signal received through the wireless receiver, the signal representing the pressure profile.

29. A therapeutic pressure application device, comprising:
a support structure shaped to conform to a portion of a body of an individual;
a bladder having a port for the passage of a fluid, the bladder being supported by the support structure;
a pump having a fluid outlet coupled to the port of the bladder, the pump having a control input; and
a controller having an output coupled to the control input of the pump, the controller comprising at least one computer storage medium, the computer storage medium comprising instructions, executable by the controller, that when executed by the controller cause the controller to transmit control signals to the pump, the control signals activating the pump to transport fluid into or out of the bladder in accordance with a pressure profile stored in a portion of the at least one computer storage medium.

30. The therapeutic pressure application device of claim 29, wherein:
the device further comprises a pressure sensor disposed adjacent to the bladder, the pressure sensor providing an output indicative of a sensed pressure; and
the instructions cause the controller to transmit control signals to the pump based on the sensed pressure and the pressure profile.

31. The therapeutic pressure application device of claim 29, further comprising:
a programming port adapted to receive data representative of the pressure profile and to store the data in the portion of the at least one computer storage medium.

32. A method of applying a deep pressure touch stimulation to an individual, the method comprising:
attaching a therapeutic pressure application device to a portion of a body of the individual, the therapeutic pressure application device comprising a bladder;
sensing a perceivable condition of the individual; and
controlling the pressure in the bladder in response to the perceivable condition.

33. The method of claim 32, wherein:
the perceivable condition comprises: a sound produced by the individual or an affect of the individual.

34. The method of claim 32, wherein:
sensing the perceivable condition comprises detecting a sound produced by the individual.

35. The method of claim 32, wherein:
sensing the perceivable condition comprises analyzing a video comprising movements or facial expressions of the individual.

36. A therapeutic pressure application device, comprising:
a support structure shaped to conform to a portion of a body of an individual;
a bladder having a port for the passage of a fluid, the bladder being supported by the support structure;
a pump having a fluid outlet coupled to the port of the bladder, the pump having a control input; and
a controller having an output coupled to the control input of the pump and an input adapted to receive at least one parameter representing a perceivable condition of a wearer of the therapeutic pressure application device, the controller comprising at least one computer storage medium, the computer storage medium comprising instructions, executable by the controller, that when executed by the controller cause the controller to transmit control signals to the pump, the control signals activating the pump to transport fluid into or out of the bladder, at times determined at least in part by the at least one parameter representing a perceivable condition of the wearer.

37. The therapeutic pressure application device of claim 36, further comprising:
an accelerometer secured to the support structure, the accelerometer having an output coupled to the input of the controller.

38. The therapeutic pressure application device of claim 36, further comprising a physiological sensor coupled to input of the controller,
wherein the physiological sensor senses a parameter representing a physiological condition, and
wherein the instructions cause the controller to transmit the control signals to the pump at times determined in further part by the parameter representing the physiological condition.

39. The therapeutic pressure application device of claim 38, wherein the physiological condition is selected from the group consisting of: heart rate, body temperature, galvanic skin response, muscle tension, blood pressure, respiratory activity, and brain wave activity.
